(19) United States
(12) Patent Application Publication
(10) Pub. No.: US 2025/0229862 A1
(43) Pub. Date: Jul. 17, 2025

(54) OPERATOR CONTROL ASSEMBLY

(71) Applicant: HAYES BICYCLE GROUP INC., Mequon, WI (US)

(72) Inventor: Kyle J. BEUTIN, Wauwatosa, WI (US)

(21) Appl. No.: 18/991,430

(22) Filed: Dec. 21, 2024

Related U.S. Application Data
(60) Provisional application No. 63/621,564, filed on Jan. 16, 2024.

(51) Int. Cl. B62K 23/02; B62J 1/08; B62K 25/08

(52) U.S. Cl. CPC B62K 23/02; B62J 2001/085; B62K 25/08

(57) ABSTRACT

A reconfigurable operator control assembly is disclosed. The assembly may comprise an operator control and a mounting structure and a post to secure the operator control; the operator control may comprise a seatpost dropper control and/or a suspension damping adjuster control. The assembly may comprise (a) the seatpost dropper control above the suspension damping adjuster control or (b) the seatpost dropper control below the suspension damping adjuster control or (c) the seatpost dropper control or (d) the suspension damping adjuster control. The assembly may comprise a stack comprising a spacer between the seatpost dropper control and the suspension damping adjuster control. The post may comprise a short post for mounting the seatpost dropper control or the suspension damping adjuster control; the post may comprise a long post for mounting the seatpost dropper control and the suspension damping adjuster control. The post may comprise a body with non-circular cross-section. The operator control may comprise a remote control.

### CROSS-REFERENCE TO RELATED APPLICATIONS

The present application claims priority to and incorporates by reference in full the following patent application: U.S. Provisional Patent Application No. 63/621,564 titled “OPERATOR CONTROL ASSEMBLY” filed Jan. 16, 2024.

### FIELD

The present invention relates to an operator control assembly for a bicycle.

### BACKGROUND

It is known to provide an operator control assembly for a bicycle.

It would be advantageous to provide an improved operator control assembly comprising a reconfigurable operator control assembly.

It would be advantageous to provide an improved operator control assembly comprising a reconfigurable operator control assembly to provide a seatpost dropper control and/or a suspension damping adjuster control.

It would be advantageous to provide an improved operator control assembly comprising a reconfigurable operator control assembly to provide the seatpost dropper control or the suspension damping adjuster control or the seatpost dropper control above the suspension damping adjuster control or the seatpost dropper control below the suspension damping adjuster control

It would be advantageous to provide an improved operator control assembly comprising a reconfigurable operator control assembly comprising a remote operator control.

### SUMMARY

The present invention relates to a reconfigurable operator control assembly configured to provide at least one configuration comprising a first operator control and/or a second operator control and a mounting structure and a post configured to secure the operator control to the mounting structure; the configuration may comprise (a) the first operator control or (b) the second operator control or (c) the first operator control above the second operator control or (d) the first operator control below the second operator control. The first operator control may comprise a remote actuator assembly and/or the second operator control may comprise a remote actuator assembly. The post may comprise (a) a short post configured for mounting a configuration comprising the first operator control or the second operator control or (b) a long post configured for mounting a configuration comprising the first operator control and the second operator control; the long post is longer than the short post. The assembly may comprise a stack comprising the first operator control and the second operator control; and a spacer between the first operator control and the second operator control; the post is configured to fit within the spacer. The first operator control may comprise a seatpost dropper control or a suspension damping adjuster control; the second operator control may comprise a seatpost dropper control or a suspension damping adjuster control. The assembly may comprise a stack comprising (a) the seatpost dropper control above the suspension damping adjuster control or (b) the seatpost dropper control under below the suspension damping adjuster control. A configuration may comprise (a) the seatpost dropper control or (b) the suspension damping adjuster control or (c) the seatpost dropper control above the suspension damping adjuster control or (d) the seatpost dropper control below the suspension damping adjuster control. A configuration may comprise (a) the seatpost dropper control the post may comprise a short post or (b) the suspension damping adjuster control the post may comprise a short post or (c) the seatpost dropper control above the suspension damping adjuster control the post may comprise a long post secured through a spacer with a fastener and a fastener to secure to the mounting structure or (d) the seatpost dropper control below the suspension damping adjuster control the post may comprise a long post secured through a spacer with a fastener and a fastener to secure to the mounting structure. The assembly may comprise a connection of a cable. The assembly may comprise a lever. The mounting structure may comprise a clamp assembly. The assembly may comprise a base plate configured to be secured to the mounting structure.

The present invention relates to a reconfigurable operator control assembly comprising an operator control comprising at least one operator control and a mounting structure and a post configured to secure the operator control to the mounting structure; the operator control may comprise a seatpost dropper control and/or a suspension damping adjuster control. The post may comprise a body; the body may comprise a non-circular cross-section. The assembly may comprise a stack comprising (a) the seatpost dropper control above the suspension damping adjuster control or (b) the seatpost dropper control under below the suspension damping adjuster control. The operator control may comprise (a) the seatpost dropper control above the suspension damping adjuster control or (b) the seatpost dropper control below the suspension damping adjuster control or (c) the seatpost dropper control or (d) the suspension damping adjuster control. The assembly may be configured to provide multiple arrangements; the post may comprise a short post or a long post; the long post is longer than the short post; the short post is configured for mounting an arrangement comprising the seatpost dropper control or the suspension damping adjuster control; the long post is configured for mounting an arrangement comprising the seatpost dropper control and the suspension damping adjuster control.

The present invention relates to a reconfigurable operator control assembly comprising a first operator control and a second operator control and a mounting structure and a post configured to secure the operator control to the mounting structure; the operator control assembly may comprise (a) the first operator control above the second operator control or (b) the first operator control below the second operator control or (c) the first operator control or (d) the second operator control. The first operator control may comprise a seatpost dropper control and the second operator control may comprise a suspension damping adjuster control. The post may comprise a short post configured for mounting the first operator control or a long post configured for mounting of the first operator control and the second operator control; the long post is longer than the short post.

The present invention relates to a reconfigurable operator control assembly configured to provide at least one configuration comprising a first operator control and/or a second operator control and a mounting structure and a post configured to secure the operator control to the mounting structure; the configuration may comprise (a) the first operator control or (b) the second operator control or (c) the first operator control above the second operator control or (d) the first operator control below the second operator control. The first operator control may comprise a remote actuator assembly and the second operator control may comprise a remote actuator assembly. The post may comprise either a short post configured for mounting the assembly comprising a single operator control or a long post configured for mounting the configuration comprising two operator controls; the long post is longer than the short post. The first operator control may comprise a seatpost dropper control and the second operator control may comprise a suspension damping adjuster control. The assembly may comprise a stack comprising a seatpost dropper control and a suspension damping adjuster control; the stack may comprise a spacer between the seatpost dropper control and the suspension damping adjuster control; the post is configured to fit within the spacer. The assembly may comprise (a) a stack comprising the seatpost dropper control above the suspension damping adjuster control or (b) a stack comprising the seatpost dropper control under below the suspension damping adjuster control. The assembly may comprise a lever. The mounting structure may comprise a clamp assembly. The assembly may comprise a base plate for the operator control; the base plate may be secured to the mounting structure; the base plate may comprise a key. The first operator control may comprise a seatpost dropper control or a suspension damping adjuster control; the second operator control may comprise a seatpost dropper control or a suspension damping adjuster control. The operator control assembly may comprise (a) the seatpost dropper control above the suspension damping adjuster control or (b) the seatpost dropper control below the suspension damping adjuster control or (c) the seatpost dropper control or (d) the suspension damping adjuster control. The operator control assembly may be mounted on a mounting structure; the operator control may comprise (a) the seatpost dropper control above the suspension damping adjuster control the post may comprise the long post secured through a spacer with a fastener and a fastener to secure to the mounting structure or (b) the seatpost dropper control below the suspension damping adjuster control the post may comprise the long post secured through a spacer with a fastener and a fastener to secure to the mounting structure or (c) the seatpost dropper control the post may comprise the short post or (d) the suspension damping adjuster control the post may comprise the short post. The assembly may be configured for connection of a cable.

The present invention relates to a reconfigurable operator control assembly comprising at least one operator control and a mounting structure and a post configured to secure the operator control to the mounting structure; the operator control assembly may comprise a seatpost dropper control or a suspension damping adjuster control. The post may comprise a body; the body may comprise a non-circular cross-section. The operator control may comprise (a) a stack comprising the seatpost dropper control above the suspension damping adjuster control or (b) a stack comprising the seatpost dropper control under below the suspension damping adjuster control. The operator control may comprise (a) the seatpost dropper control above the suspension damping adjuster control or (b) the seatpost dropper control below the suspension damping adjuster control or (c) the seatpost dropper control or (d) the suspension damping adjuster control. The assembly may be configured to provide multiple arrangements; the post may comprise either a short post configured for mounting an arrangement comprising a single operator control or a long post configured for mounting an arrangement comprising two operator controls; the long post is longer than the short post. The post may comprise a body; the body may comprise a hex and/or non-circular cross-section.

The present invention relates to a reconfigurable operator control assembly comprising a first operator control and a second operator control and a mounting structure and a post configured to secure the operator control to the mounting structure; the operator control assembly may comprise (a) the first operator control above the second operator control or (b) the first operator control below the second operator control or (c) the first operator control or (d) the second operator control. The first operator control may comprise a seatpost dropper control and the second operator control may comprise a suspension damping adjuster control. The post may comprise either a short post configured for mounting a single operator control or a long post configured for mounting of two operator controls. The assembly may be configured to provide multiple arrangements; the post may comprise either a short post configured for mounting an arrangement comprising a single operator control or a long post configured for mounting an arrangement comprising two operator controls; the long post is longer than the short post. The post may comprise a body; the body may comprise a hex and/or non-circular cross-section.

The present invention relates to a reconfigurable operator control assembly configured to provide at least one configuration; the assembly may comprise a first operator control and/or a second operator control and a mounting structure and a post configured to secure the operator control to the mounting structure; the configuration may comprise (a) the first operator control or (b) the second operator control or (c) the first operator control above the second operator control or (d) the first operator control under the second operator control. The first operator control and/or the second operator control may comprise an operator control. The first operator control may comprise the seatpost dropper control. The second operator control may comprise the suspension damping adjuster control. The first operator control may comprise an actuator assembly and the second operator control may comprise an actuator assembly. The first operator control may comprise a remote actuator assembly and the second operator control may comprise a remote actuator assembly. The first operator control may comprise a seatpost dropper control and the second operator control may comprise a suspension damping adjuster control. The assembly may comprise a spacer between the seatpost dropper control and the suspension damping adjuster control. The post may be configured to mount the operator control to the mounting structure. The post may comprise a short post. The post may comprise either a short post or a long post. The post may comprise either a short post configured for mounting a single operator control or a long post configured for mounting of two operator controls. The post may comprise either a short post configured for mounting the configuration comprising a single operator control or a long post configured for mounting the configuration comprising two operator controls. The post may comprise a long post configured to secure a spacer between the seatpost dropper control and the suspension damping adjuster control. The assembly may comprise a stack comprising the seatpost dropper control above the suspension damping adjuster control; the stack may comprise the seatpost dropper control under the suspension damping adjuster control; the stack may comprise the spacer between the seatpost dropper control and the suspension damping adjuster control. The spacer may comprise a bushing. The spacer may comprise a tube. The post may be configured to fit within the spacer. The post may be configured to be secured to the spacer by a fastener. The post may be configured to be secured with the spacer by a screw. The post may comprise a square cross-section; the post may comprise a flat-sided cross-section; the post may comprise a noncylindrical cross-section; the post may comprise a pin. The post may be configured to be secured by a fastener; the post may be configured to be secured by a threaded fastener; the post may be configured to be secured by a screw. The operator control assembly may comprise a remote control; the remote control may be actuated by a cable arrangement. The operator control assembly may comprise an aperture for the post. The operator control assembly may comprise (a) a stack comprising the seatpost dropper control above the suspension damping adjuster control or (b) a stack comprising the seatpost dropper control under the suspension damping adjuster control. The operator control assembly may comprise a lever; the operator control assembly may comprise a lever for a remote control. The mounting structure may comprise a clamp assembly. The mounting structure may comprise a mounting plate. The mounting structure may comprise a mounting plate configured to provide multiple mounting positions. The assembly may comprise a base plate for the operator control. The base plate may be secured to the mounting structure; the base plate may comprise a hole; the base plate may comprise a key. The operator control assembly may comprise (a) the seatpost dropper control above the suspension damping adjuster control or (b) the seatpost dropper control under the suspension damping adjuster control or (c) the seatpost dropper control or (d) the suspension damping adjuster control. The operator control assembly may comprise (a) the seatpost dropper control above the suspension damping adjuster control and the post may comprise the long post or (b) the seatpost dropper control under the suspension damping adjuster control and the post may comprise the long post or (c) the seatpost dropper control and the post may comprise the short post or (d) the suspension damping adjuster control and the post may comprise the short post. The operator control assembly may comprise (a) the seatpost dropper control above the suspension damping adjuster control and the post may comprise the long post secured through a spacer or (b) the seatpost dropper control under the suspension damping adjuster control and the post may comprise the long post secured through a spacer or (c) the seatpost dropper control and the post may comprise the short post or (d) the suspension damping adjuster control and the post may comprise the short post. The operator control assembly may be mounted on a mounting structure; the operator control may comprise (a) the seatpost dropper control above the suspension damping adjuster control and the post may comprise the long post secured through a spacer and a fastener to secure to the mounting structure or (b) the seatpost dropper control under the suspension damping adjuster control and the post may comprise the long post secured through a spacer and a fastener to secure to the mounting structure or (c) the seatpost dropper control and the post may comprise the short post or (d) the suspension damping adjuster control and the post may comprise the short post. The operator control assembly may be mounted on a mounting structure; the operator control may comprise (a) the seatpost dropper control above the suspension damping adjuster control and the post may comprise the long post secured through a spacer with a fastener and a fastener to secure to the mounting structure or (b) the seatpost dropper control under the suspension damping adjuster control and the post may comprise the long post secured through a spacer with a fastener and a fastener to secure to the mounting structure or (c) the seatpost dropper control and the post may comprise the short post or (d) the suspension damping adjuster control and the post may comprise the short post. The operator control assembly may be configured for connection of a cable.

The present invention relates to a reconfigurable operator control assembly; the assembly may comprise at least one operator control and a mounting structure and a post configured to secure the operator control to the mounting structure. The operator control assembly may comprise a seatpost dropper control or a suspension damping adjuster control. The operator control may comprise an actuator assembly; the operator control may comprise a remote actuator assembly. The post may be configured to mount the operator control to the mounting structure; the post may comprise a short post. The operator control may comprise the seatpost dropper control. The operator control may comprise the suspension damping adjuster control. The post may comprise either a short post configured for mounting a single operator control or a long post configured for mounting of two operator controls. The post may comprise a square cross-section. The post may comprise a flat-sided cross-section. The post may comprise a noncylindrical cross-section. The post may comprise a pin. The post may be configured to be secured by a fastener. The post may be configured to be secured by a threaded fastener. The post may be configured to be secured by a screw. The operator control may comprise a seatpost dropper control and a suspension damping adjuster control. The assembly may comprise a spacer between the seatpost dropper control and the suspension damping adjuster control. The post may comprise a long post configured to secure the spacer between the seatpost dropper control and the suspension damping adjuster control. The assembly may comprise a stack comprising the seatpost dropper control above the suspension damping adjuster control; the stack may comprise the seatpost dropper control under the suspension damping adjuster control; the stack may comprise a spacer between the seatpost dropper control and the suspension damping adjuster control; the spacer may comprise a bushing and/or a tube. The post may be configured to fit within the spacer. The post may be configured to be secured to the spacer by a fastener; the post may be configured to be secured with the spacer by a screw. The operator control may comprise a remote control. The operator control may comprise an aperture for the post. The operator control may comprise (a) a stack comprising the seatpost dropper control above the suspension damping adjuster control and the n (b) a stack comprising the seatpost dropper control under the suspension damping adjuster control. The operator control may comprise a lever; the operator control may comprise a lever for a remote control. The mounting structure may comprise a clamp assembly; the mounting structure may comprise a mounting plate; the mounting structure may comprise a mounting plate configured to provide multiple mounting positions. The assembly may comprise a base plate for the operator control; the base plate may be secured to the mounting structure; the base plate may comprise a hole; the base plate may comprise a key. The operator control may comprise (a) the seatpost dropper control above the suspension damping adjuster control or (b) the seatpost dropper control under the suspension damping adjuster control or (c) the seatpost dropper control or (d) the suspension damping adjuster control. The operator control may comprise (a) the seatpost dropper control above the suspension damping adjuster control and the post may comprise the long post or (b) the seatpost dropper control under the suspension damping adjuster control and the post may comprise the long post or (c) the seatpost dropper control and the post may comprise the short post or (d) the suspension damping adjuster control and the post may comprise the short post. The operator control may comprise (a) the seatpost dropper control above the suspension damping adjuster control and the post may comprise the long post secured through a spacer or (b) the seatpost dropper control under the suspension damping adjuster control and the post may comprise the long post secured through a spacer or (c) the seatpost dropper control and the post may comprise the short post or (d) the suspension damping adjuster control and the post may comprise the short post. The operator control may be mounted on a mounting structure; the operator control may comprise (a) the seatpost dropper control above the suspension damping adjuster control and the post may comprise the long post secured through a spacer and a fastener to secure to the mounting structure or (b) the seatpost dropper control under the suspension damping adjuster control and the post may comprise the long post secured through a spacer and a fastener to secure to the mounting structure or (c) the seatpost dropper control and the post may comprise the short post or (d) the suspension damping adjuster control and the post may comprise the short post. The operator control may be mounted on a mounting structure; the operator control may comprise (a) the seatpost dropper control above the suspension damping adjuster control and the post may comprise the long post secured through a spacer with a fastener and a fastener to secure to the mounting structure or (b) the seatpost dropper control under the suspension damping adjuster control and the post may comprise the long post secured through a spacer with a fastener and a fastener to secure to the mounting structure or (c) the seatpost dropper control and the post may comprise the short post or (d) the suspension damping adjuster control and the post may comprise the short post. The operator control may be configured for connection of a cable.

The present invention relates to a reconfigurable operator control assembly configured to be mounted on a handlebar for a bicycle; the assembly may comprise at least one operator control and a mounting structure and a post configured to secure the operator control to the mounting structure; the operator control assembly may comprise a seatpost dropper control or a suspension damping adjuster control. The operator control may comprise a remote actuator; the operator control may comprise a remote seatpost dropper control and a remote suspension damping adjuster control. The mounting structure may comprise a mounting plate configured to provide multiple mounting positions for the operator control. The mounting structure may comprise a mounting plate configured to provide at least two mounting positions for the operator control.

The present invention relates to a reconfigurable operator control assembly configured to be mounted on a handlebar for a bicycle; the assembly may comprise a first operator control and a second operator control and a mounting structure and a post configured to secure the operator control to the mounting structure; The operator control assembly may comprise (a) the first operator control above the second operator control and the post may comprise the long post secured through a spacer with a fastener and a fastener to secure to the mounting structure or (b) the first operator control under the second operator control and the post may comprise the long post secured through a spacer with a fastener and a fastener to secure to the mounting structure or (c) the first operator control and the post may comprise the short post or (d) the second operator control and the post may comprise the short post. The first operator control may comprise a seatpost dropper control and the second operator control may comprise a suspension damping adjuster control.

The present invention relates to a reconfigurable operator control assembly configured to be mounted on a handlebar for a bicycle may comprise at least one operator control and a mounting structure and a post configured to secure the operator control to the mounting structure; The operator control assembly may comprise a seatpost dropper control or a suspension damping adjuster control; the operator control assembly may be mounted on a mounting structure; the operator control assembly may comprise (a) the seatpost dropper control above the suspension damping adjuster control and the post may comprise the long post secured through a spacer with a fastener and a fastener to secure to the mounting structure or (b) the seatpost dropper control under the suspension damping adjuster control and the post may comprise the long post secured through a spacer with a fastener and a fastener to secure to the mounting structure or (c) the seatpost dropper control and the post may comprise the short post or (d) the suspension damping adjuster control and the post may comprise the short post. The operator control may comprise a remote actuator.

The present invention relates to a reconfigurable operator control assembly; the assembly may comprise a first operator control and a second operator control for mounting on a mounting structure and a post configured to secure the operator control to the mounting structure; the operator control assembly may comprise (a) the first operator control above the second operator control or (b) the first operator control under the second operator control or (c) the first operator control or (d) the second operator control.

### FIGURES

FIG. 1 is schematic perspective view of a bicycle according to an exemplary embodiment.

FIGS. 2A through 2D are schematic perspective views of a reconfigurable operator control assembly for a bicycle according to an exemplary embodiment.

FIGS. 3A and 3B are a schematic perspective views of a component for a reconfigurable operator control assembly for a bicycle according to an exemplary embodiment.

FIG. 4 is a schematic perspective views of a component for a reconfigurable operator control assembly for a bicycle according to an exemplary embodiment.

FIG. 5 is a schematic exploded perspective view of a reconfigurable operator control assembly for a bicycle according to an exemplary embodiment.

FIG. 6A is a schematic perspective view of a reconfigurable operator control assembly for a bicycle according to an exemplary embodiment.

FIG. 6B is a schematic front elevation view of a reconfigurable operator control assembly for a bicycle according to an exemplary embodiment.

FIG. 6C is a schematic exploded perspective view of a reconfigurable operator control assembly for a bicycle according to an exemplary embodiment.

FIG. 7A is a schematic perspective view of a reconfigurable operator control assembly for a bicycle according to an exemplary embodiment.

FIG. 7B is a schematic front elevation view of a reconfigurable operator control assembly for a bicycle according to an exemplary embodiment.

FIG. 7C is a schematic exploded perspective view of a reconfigurable operator control assembly for a bicycle according to an exemplary embodiment.

FIG. 8A is a schematic perspective view of a reconfigurable operator control assembly for a bicycle according to an exemplary embodiment.

FIG. 8B is a schematic exploded perspective view of a reconfigurable operator control assembly for a bicycle according to an exemplary embodiment.

FIG. 9A is a schematic perspective view of a reconfigurable operator control assembly for a bicycle according to an exemplary embodiment.

FIG. 9B is a schematic exploded perspective view of a reconfigurable operator control assembly for a bicycle according to an exemplary embodiment.

### DESCRIPTION

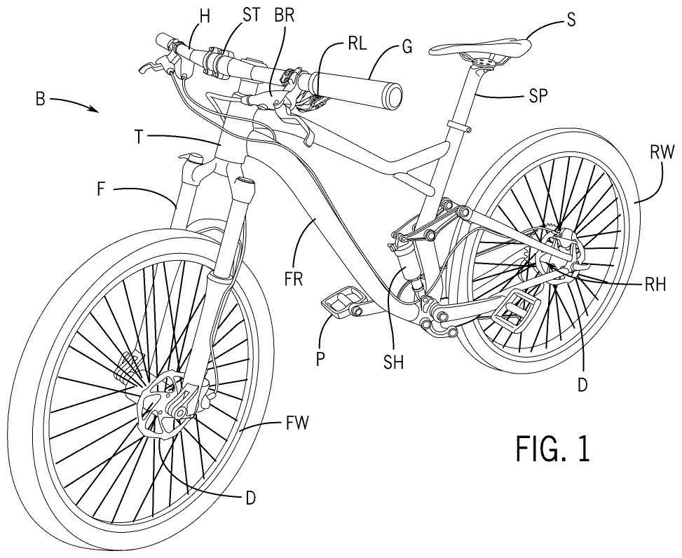

Referring to FIG. 1, a bicycle B is shown schematically according to an exemplary embodiment providing an arrangement of parts/components including a frame FR with a head tube T and a seat post SP (with seat S) and a set of wheels comprising front wheel FW with a front fork/suspension assembly F and rear wheel RW coupled to the frame FR (through a suspension system) and a set of pedals; the bicycle provides handlebar H (coupled to front wheel FW through stem ST and front fork assembly F and through head tube T) with grip G and with operator control RL (shown with remote lever) and with operator control for a brake system BR coupled to a brake disc D (e.g. rotor at/on each of front wheel FW and rear wheel RW) and a gear/shift control (coupled to a selectable gear system for rear wheel RW).

### Exemplary Embodiments—A

As indicated schematically according to an exemplary embodiment in FIGS. 1, 2A-2D, 3A-3B, 5, 6A-6C, 7A-7C, 8A-8B and 9A-9B, a reconfigurable operator control assembly RL/110/210 and RL/310/410 may be configured to provide at least one configuration; the assembly RL/110/210 and RL/310/410 may comprise an operator control shown as an actuator assembly 100 for a dropper seatpost and/or an operator control shown as an actuator assembly 150 for a suspension damping adjuster control (such as lockout) and a mounting structure shown as clamp assembly 20 and a post 12/312 configured to secure the operator control to the mounting structure.

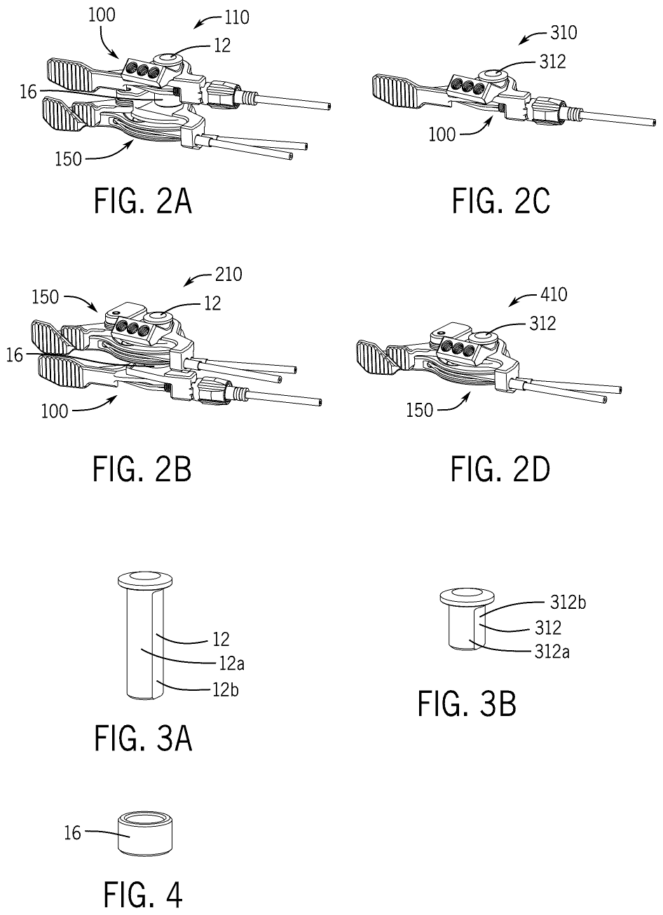

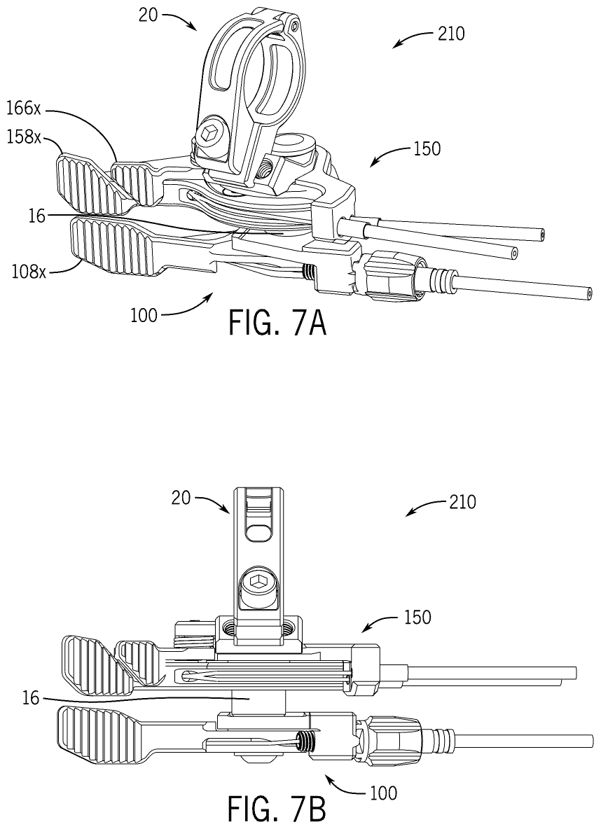

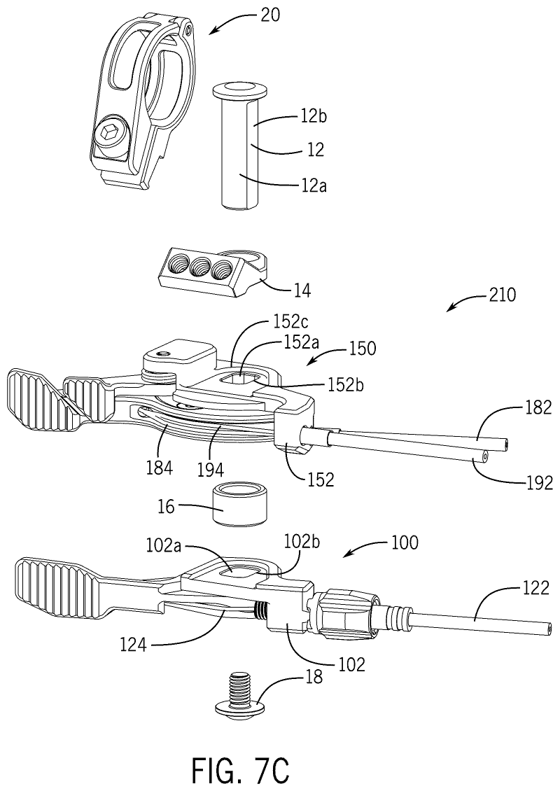

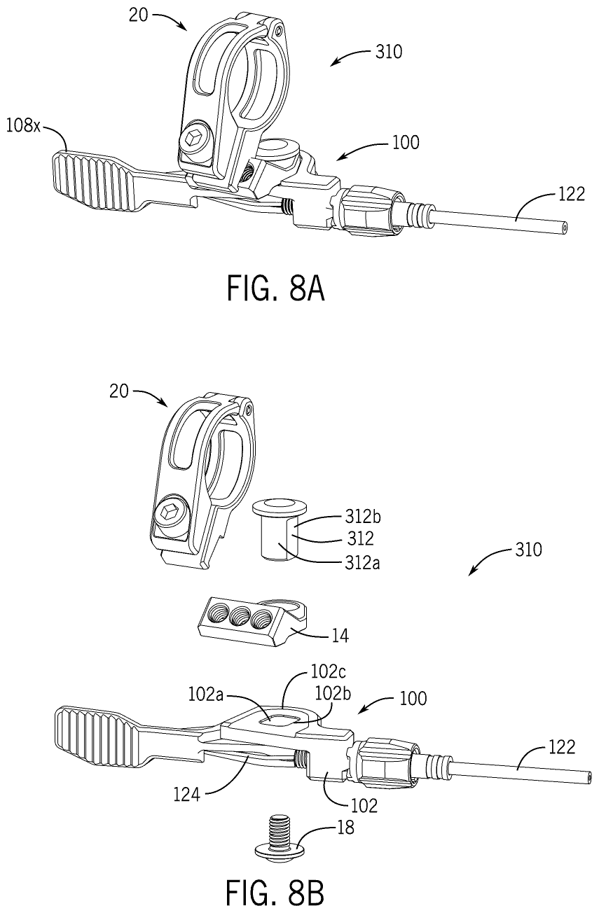

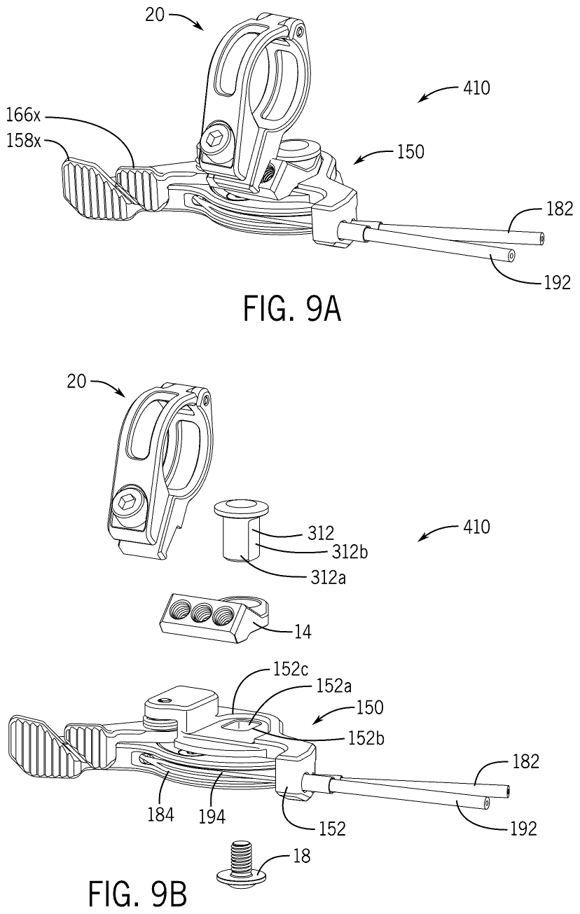

As indicated schematically according to an exemplary embodiment in FIGS. 1, 2A-2D, 3A-3B, 5, 6A-6C, 7A-7C, 8A-8B and 9A-9B, a first operator control and/or a second operator control may comprise operator control assembly RL/110/210 and RL/310/410; the configuration may comprise (a) the operator control assembly RL/310 with a first operator control to provide an actuator assembly 100 for a dropper seatpost (FIGS. 2C and 8A-8B) or (b) the operator control assembly RL/410 with a second operator control to provide an actuator assembly 150 for a suspension damping adjuster control (FIGS. 2D and 9A-9D) or (c) an operator control assembly RL/110 with the first operator control 100 above the second operator control 150 (FIGS. 2A and 6A-6C) or (d) an operator control assembly RL/210 with the first operator control 100 under the second operator control 150 (FIGS. 2B and 7A-7C).

As indicated schematically according to an exemplary embodiment in FIGS. 1, 2A-2C, 6A-6C, 7A-7C and 8A-8B, the reconfigurable operator control assembly RL/110/210 and RL/310 may be configured to provide the first operator control 100 as the seatpost dropper control.

As indicated schematically according to an exemplary embodiment in FIGS. 1, 2A-2B, 2D, 6A-6C, 7A-7C and 9A-9B, the reconfigurable operator control assembly RL/110/210 and RL/410 may be configured to provide the second operator control 150 as the suspension damping adjuster control.

As indicated schematically according to an exemplary embodiment in FIGS. 1, 2A-2B, 2D, 6A-6C, 7A-7C and 9A-9B, the reconfigurable operator control assembly RL/110/210 and RL/410 may be configured to provide the first operator control 100 as the seatpost dropper and the second operator control 150 as the suspension damping adjuster control. As indicated schematically according to an exemplary embodiment in FIGS. 1 and 2A-2D, the first operator control may comprise a remote actuator assembly RL and/or the second operator control may comprise a remote actuator assembly RL.

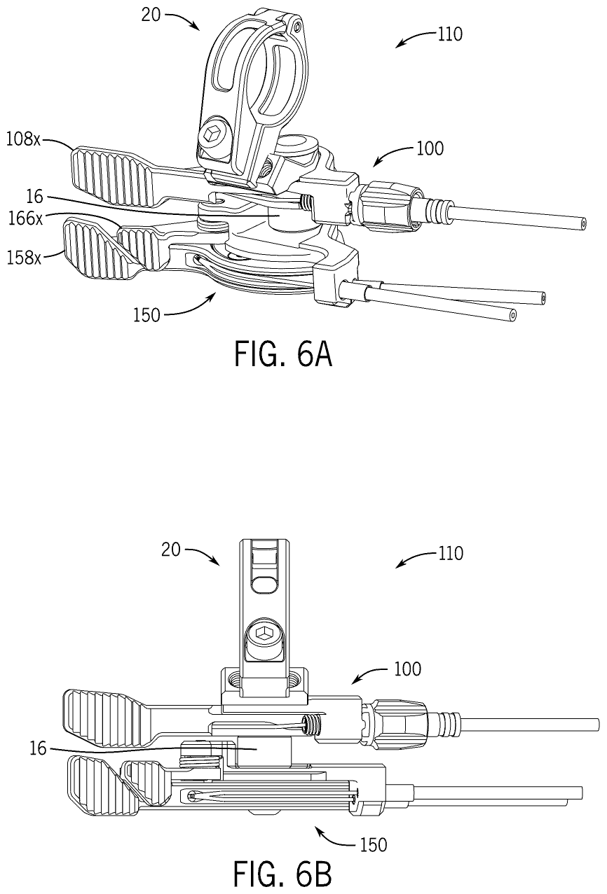

As indicated schematically according to an exemplary embodiment in FIGS. 2A-2B, 3A, 4, 5, 6A-6C and 7A-7C, the assembly may comprise a spacer 16 between the seatpost dropper control and the suspension damping adjuster control.

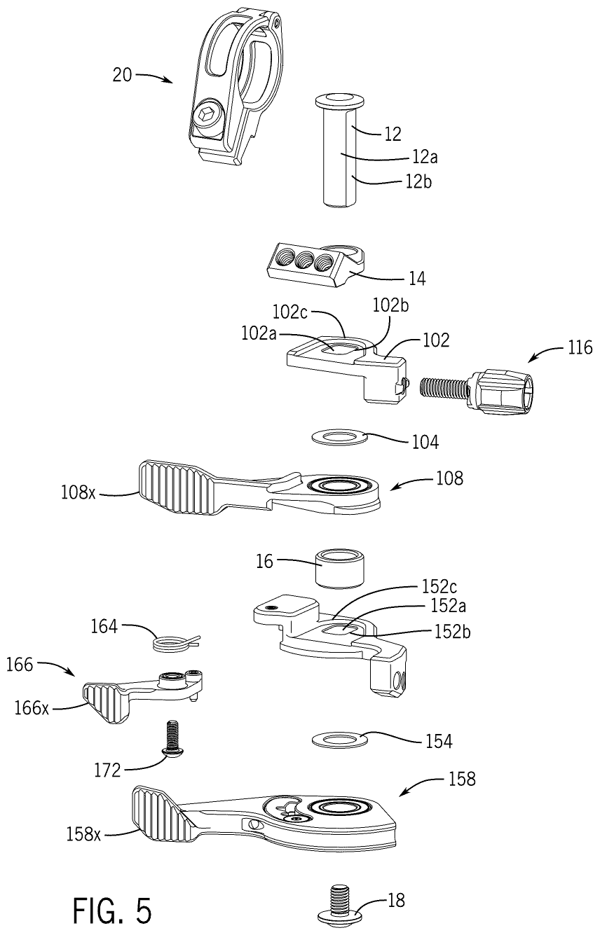

As indicated schematically according to an exemplary embodiment in FIGS. 2A-2D, 3A-3B, 5, 6A-6C, 7A-7C, 8A-8B and 9A-9B, the post 12/312 may be configured to mount the operator control 110/150 to the mounting structure 20; the post may comprise either a short post 312 configured for mounting a single operator control as in assembly RL/310/410 or a long post 12 configured for mounting of two operator controls as in assembly RL/110/210. As indicated schematically in FIGS. 2A-2D and 3A-3B, the post may comprise either a short post 312 configured for mounting the configuration comprising a single operator control or a long post 12 configured for mounting the configuration comprising two operator controls. As indicated schematically according to an exemplary embodiment in FIGS. 2A-2B, 3A, 4, 5, 6A-6C and 7A-7C, the post may comprise a long post 12 configured to secure a spacer 16 between the actuator assembly 100 for seatpost dropper control and the actuator assembly 150 for suspension damping adjuster control. The operator control assembly may comprise an aperture for the post.

As indicated schematically according to an exemplary embodiment in FIGS. 2A-2B, 3A-3B, 4 and 5, the assembly may comprise a mount arrangement comprising a mounting plate 20 and a mounting structure comprising a mounting plate 14 configured to fit with a base plate 102 with washer 104 for lever assembly 108 (see also FIG. 6C) and/or a base plate 152 with washer 154 for lever assembly 158 and lever assembly 166 on torsion spring 164 secured together with fastener 172 (see also FIG. 7C); the assembly may comprise an adjuster assembly 116; the assembly of mount plate 14 and actuator assembly 100 with base plate 102 on bushing with actuator assembly with base plate 152 is secured with long post/pin 12 and fastener 18 (see FIGS. 6A-6C and 7A-7C); the assembly of mount plate 14 and actuator assembly 100 with base plate 102 or with base plate 152 is secured with short post/pin 312 and fastener 18 (see FIGS. 8A-8B and 9A-9B). See also FIGS. 6A-6C, 7A-7C, 8A-8B and 9A-9B.

As indicated schematically according to an exemplary embodiment in FIGS. 2A-2B, 3A, 4, 5, 6A-6C and 7A-7C, the assembly may comprise a stack comprising the seatpost dropper control above the suspension damping adjuster control; the stack may comprise the seatpost dropper control under the suspension damping adjuster control; the stack may comprise the spacer between the seatpost dropper control and the suspension damping adjuster control.

As indicated schematically according to an exemplary embodiment in FIGS. 2A-2B, 3A, 4, 5, 6A-6C and 7A-7C, the spacer may comprise a bushing; the spacer may comprise a tube; the post 12 may be configured to fit within the spacer 16; the post may be configured to be secured to the spacer by a fastener 18 such as a screw; the post 12/312 may comprise a noncylindrical cross-section; the post may comprise a pin; the post may be configured to be secured by a fastener; the post may be configured to be secured by a threaded fastener; the post may be configured to be secured by a screw. As indicated schematically in FIG. 3A, the long post 12 may comprise a square cross-section with flats 12b; the post may comprise a flat-sided cross-section with flats 12b and cylindrical surfaces 12a. As indicated schematically in FIG. 3B, the short post 312 may comprise a square cross-section with flats 312b; the post may comprise a flat-sided cross-section with flats 312b and cylindrical surfaces 312a.

As indicated schematically according to an exemplary embodiment in FIGS. 1, 2A-2D, 3A-3B, 5, 6A-6C, 7A-7C, 8A-8B and 9A-9B, the operator control assembly may comprise a remote control RL; the remote control may be actuated by a cable arrangement comprising cable 124 and housing 122 (see FIGS. 2A-2C, 6A-6C, 7A-7C and 8A-8B) and/or cable 184/194 and housing 182/192 (see FIGS. 2A-2B, 2D, 6A-6C, 7A-7C and 9A-9B).

As indicated schematically according to an exemplary embodiment in FIGS. 2A-2D, 3A-3B, 5, 6A-6C, 7A-7C, 8A-8B and 9A-9B, the operator control assembly may comprise a lever for a remote control RL; the operator control assembly may comprise a lever assembly 108 with lever pad 108x for actuator assembly 100 for the seatpost dropper control; the operator control assembly may comprise a lever assembly 158 comprising lever pad 158x and a lever assembly 166 comprising lever pad 166x for actuator assembly 150 for the suspension damping adjuster control.

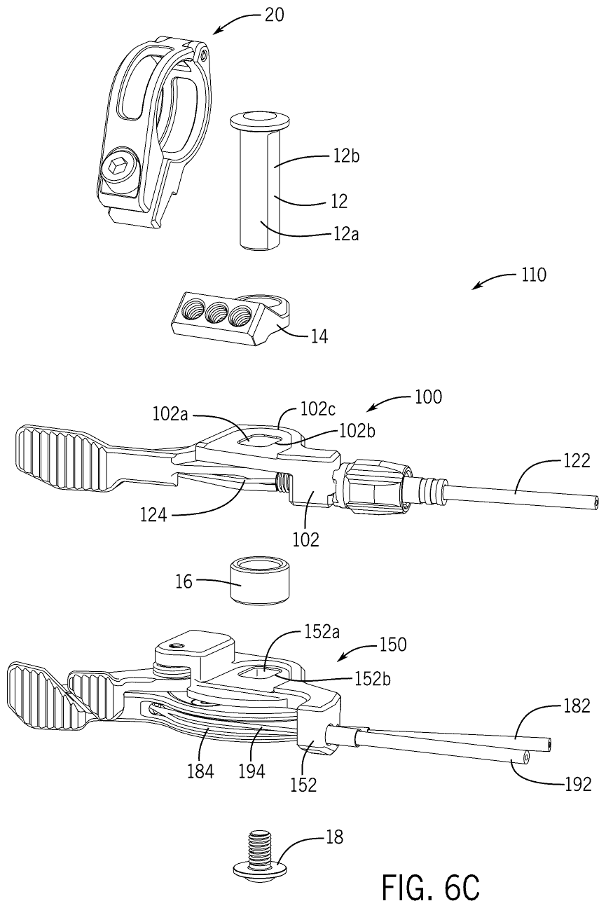

As indicated schematically according to an exemplary embodiment in FIGS. 2A-2D, 3A-3B, 5, 6A-6C, 7A-7C, 8A-8B and 9A-9B, the mounting structure may comprise a clamp assembly 20 with a mounting plate 14; as indicated schematically in FIG. 5, the mounting structure may comprise a mounting plate 14 configured to provide multiple mounting positions (e.g. by securing the mount in alternative mounting holes/apertures).

As indicated schematically according to an exemplary embodiment in FIGS. 6A-6C and 8A-8B, the mounting arrangement for the actuator assembly 100 may comprise a base plate 102 for the operator control; the base plate 102 may be secured to the mounting structure shown as mount plate 14; the base plate 102 may comprise a hole 102a; the base plate may comprise a key 102b; the base plate may comprise a recess/seat 102c to retain the mount plate 14.

As indicated schematically according to an exemplary embodiment in FIGS. 7A-7C and 9A-9B, the mounting arrangement for the actuator assembly 150 may comprise a base plate 152 for the operator control; the base plate 152 may be secured to the mounting structure shown as mount plate 14; the base plate 152 may comprise a hole 152a; the base plate may comprise a key 152b; the base plate may comprise a recess/seat 152c to retain the mount plate 14.

As indicated schematically according to an exemplary embodiment in FIGS. 2A-2D, 3A-3B, 5, 6A-6C, 7A-7C, 8A-8B and 9A-9B, the operator control assembly may comprise (a) the seatpost dropper control above the suspension damping adjuster control or (b) the seatpost dropper control under the suspension damping adjuster control or (c) the seatpost dropper control or (d) the suspension damping adjuster control.

As indicated schematically according to an exemplary embodiment in FIGS. 2A-2D, 3A-3B, 5, 6A-6C, 7A-7C, 8A-8B and 9A-9B, the operator control assembly may comprise (a) the seatpost dropper control above the suspension damping adjuster control and the post may comprise the long post or (b) the seatpost dropper control under the suspension damping adjuster control and the post may comprise the long post or (c) the seatpost dropper control and the post may comprise the short post or (d) the suspension damping adjuster control and the post may comprise the short post.

As indicated schematically according to an exemplary embodiment in FIGS. 2A-2D, 3A-3B, 5, 6A-6C, 7A-7C, 8A-8B and 9A-9B, the operator control assembly may comprise (a) the seatpost dropper control above the suspension damping adjuster control and the post may comprise the long post secured through a spacer or (b) the seatpost dropper control under the suspension damping adjuster control and the post may comprise the long post secured through a spacer or (c) the seatpost dropper control and the post may comprise the short post or (d) the suspension damping adjuster control and the post may comprise the short post.

As indicated schematically according to an exemplary embodiment in FIGS. 2A-2D, 3A-3B, 5, 6A-6C, 7A-7C, 8A-8B and 9A-9B, the operator control assembly may be mounted on a mounting structure; the operator control may comprise (a) the seatpost dropper control above the suspension damping adjuster control and the post may comprise the long post secured through a spacer and a fastener to secure to the mounting structure or (b) the seatpost dropper control under the suspension damping adjuster control and the post may comprise the long post secured through a spacer and a fastener to secure to the mounting structure or (c) the seatpost dropper control and the post may comprise the short post and a fastener to secure to the mounting structure or (d) the suspension damping adjuster control and the post may comprise the short post and a fastener to secure to the mounting structure.

As indicated schematically according to an exemplary embodiment in FIGS. 2A-2D, 3A-3B, 5, 6A-6C, 7A-7C, 8A-8B and 9A-9B, the operator control assembly may be mounted on a mounting structure; the operator control may comprise (a) the seatpost dropper control above the suspension damping adjuster control and the post may comprise the long post secured through a spacer with a fastener and a fastener to secure to the mounting structure or (b) the seatpost dropper control under the suspension damping adjuster control and the post may comprise the long post secured through a spacer with a fastener and a fastener to secure to the mounting structure or (c) the seatpost dropper control and the post may comprise the short post with a fastener and a fastener to secure to the mounting structure or (d) the suspension damping adjuster control and the post may comprise the short post with a fastener and a fastener to secure to the mounting structure.

As indicated schematically according to an exemplary embodiment in FIGS. 2A-2D, 3A-3B, 5, 6A-6C, 7A-7C, 8A-8B and 9A-9B, the operator control assembly may be configured for connection of a cable.

As indicated schematically according to an exemplary embodiment in FIGS. 2A-2D, a reconfigurable operator control assembly may comprise at least one operator control and a mounting structure and a post configured to secure the operator control to the mounting structure.

As indicated schematically according to an exemplary embodiment in FIGS. 2A-2D, 3A-3B, 5, 6A-6C, 7A-7C, 8A-8B and 9A-9B, the operator control assembly may comprise a seatpost dropper control or a suspension damping adjuster control.

As indicated schematically according to an exemplary embodiment in FIGS. 2A-2D, 3A-3B, 5, 6A-6C, 7A-7C, 8A-8B and 9A-9B, the operator control may comprise an actuator assembly; the operator control may comprise a remote actuator assembly.

The post may be configured to mount the operator control to the mounting structure; the post may comprise a short post.

As indicated schematically according to an exemplary embodiment in FIGS. 2A-2D, 3A-3B, 5, 6A-6C, 7A-7C, 8A-8B and 9A-9B, the operator control may comprise the seatpost dropper control.

As indicated schematically according to an exemplary embodiment in FIGS. 2A-2D, 3A-3B, 5, 6A-6C, 7A-7C, 8A-8B and 9A-9B, the operator control may comprise the suspension damping adjuster control.

As indicated schematically according to an exemplary embodiment in FIGS. 2A-2D, 3A-3B, 5, 6A-6C, 7A-7C, 8A-8B and 9A-9B, the operator control may comprise a suspension lockout control.

As indicated schematically according to an exemplary embodiment in FIGS. 2A-2D, 3A-3B, 5, 6A-6C, 7A-7C, 8A-8B and 9A-9B, the post may comprise either a short post configured for mounting a single operator control or a long post configured for mounting of two operator controls. The post may comprise a square cross-section. The post may comprise a flat-sided cross-section. The post may comprise a noncylindrical cross-section. The post may comprise a pin. The post may be configured to be secured by a fastener. The post may be configured to be secured by a threaded fastener. The post may be configured to be secured by a screw.

As indicated schematically according to an exemplary embodiment in FIGS. 2A-2D, 3A-3B, 5, 6A-6C, 7A-7C, 8A-8B and 9A-9B, the operator control may comprise a seatpost dropper control and a suspension damping adjuster control.

The assembly may comprise a spacer between the seatpost dropper control and the suspension damping adjuster control.

The post may comprise a long post configured to secure the spacer between the seatpost dropper control and the suspension damping adjuster control.

As indicated schematically according to an exemplary embodiment in FIGS. 2A-2D, 3A-3B, 5, 6A-6C, 7A-7C, 8A-8B and 9A-9B, the operator control may comprise a remote actuator RL.

As indicated schematically according to an exemplary embodiment in FIGS. 2A-2D, 5, 6A-6C, 7A-7C, 8A-8B, and 9A-9B, a reconfigurable operator control assembly may comprise a first operator control and a second operator control for mounting on a mounting structure and a post configured to secure the operator control to the mounting structure; the operator control assembly may comprise (a) the first remote operator control above the second remote operator control or (b) the first remote operator control under the second remote operator control or (c) the first remote operator control or (d) the second remote operator control.

### Exemplary Embodiments—B

As shown schematically in the FIGURES, a reconfigurable operator control assembly may comprise an operator control and a mounting structure and a post configured to secure the operator control to the mounting structure; the operator control may comprise a seatpost dropper control and/or a suspension damping adjuster control. The assembly may be configured to provide (a) the seatpost dropper control or (b) the suspension damping adjuster control or (c) the seatpost dropper control above the suspension damping adjuster control or (d) the seatpost dropper control below the suspension damping adjuster control. The assembly may comprise a stack comprising a spacer between the seatpost dropper control and the suspension damping adjuster control. The post may comprise a short post configured for mounting the seatpost dropper control or the suspension damping adjuster control; the post may comprise a long post configured for mounting the seatpost dropper control and the suspension damping adjuster control. The post may comprise a body comprising a non-circular cross-section. The operator control may comprise a remote control.

A reconfigurable operator control assembly may be configured to provide at least one configuration comprising a first operator control and/or a second operator control and a mounting structure and a post configured to secure the operator control to the mounting structure; the configuration may comprise (a) the first operator control or (b) the second operator control or (c) the first operator control above the second operator control or (d) the first operator control below the second operator control. The first operator control may comprise a remote actuator assembly and/or the second operator control may comprise a remote actuator assembly. The post may comprise (a) a short post configured for mounting a configuration comprising the first operator control or the second operator control or (b) a long post configured for mounting a configuration comprising the first operator control and the second operator control; the long post is longer than the short post. The assembly may comprise a stack comprising the first operator control and the second operator control; and a spacer between the first operator control and the second operator control; the post is configured to fit within the spacer. The first operator control may comprise a seatpost dropper control or a suspension damping adjuster control; the second operator control may comprise a seatpost dropper control or a suspension damping adjuster control. The assembly may comprise a stack comprising (a) the seatpost dropper control above the suspension damping adjuster control or (b) the seatpost dropper control under below the suspension damping adjuster control. A configuration may comprise (a) the seatpost dropper control or (b) the suspension damping adjuster control or (c) the seatpost dropper control above the suspension damping adjuster control or (d) the seatpost dropper control below the suspension damping adjuster control. A configuration may comprise (a) the seatpost dropper control the post may comprise a short post or (b) the suspension damping adjuster control the post may comprise a short post or (c) the seatpost dropper control above the suspension damping adjuster control the post may comprise a long post secured through a spacer with a fastener and a fastener to secure to the mounting structure or (d) the seatpost dropper control below the suspension damping adjuster control the post may comprise a long post secured through a spacer with a fastener and a fastener to secure to the mounting structure. The assembly may comprise a connection of a cable. The assembly may comprise a lever. The mounting structure may comprise a clamp assembly. The assembly may comprise a base plate configured to be secured to the mounting structure.

A reconfigurable operator control assembly may comprise an operator control comprising at least one operator control and a mounting structure and a post configured to secure the operator control to the mounting structure; the operator control may comprise a seatpost dropper control and/or a suspension damping adjuster control. The post may comprise a body; the body may comprise a non-circular cross-section. The assembly may comprise a stack comprising (a) the seatpost dropper control above the suspension damping adjuster control or (b) the seatpost dropper control under below the suspension damping adjuster control. The operator control may comprise (a) the seatpost dropper control above the suspension damping adjuster control or (b) the seatpost dropper control below the suspension damping adjuster control or (c) the seatpost dropper control or (d) the suspension damping adjuster control. The assembly may be configured to provide multiple arrangements; the post may comprise a short post or a long post; the long post is longer than the short post; the short post is configured for mounting an arrangement comprising the seatpost dropper control or the suspension damping adjuster control; the long post is configured for mounting an arrangement comprising the seatpost dropper control and the suspension damping adjuster control.

A reconfigurable operator control assembly may comprise a first operator control and a second operator control and a mounting structure and a post configured to secure the operator control to the mounting structure; the operator control assembly may comprise (a) the first operator control above the second operator control or (b) the first operator control below the second operator control or (c) the first operator control or (d) the second operator control. The first operator control may comprise a seatpost dropper control and the second operator control may comprise a suspension damping adjuster control. The post may comprise a short post configured for mounting the first operator control or a long post configured for mounting of the first operator control and the second operator control; the long post is longer than the short post.

A reconfigurable operator control assembly may provide at least one configuration; the assembly may comprise a first operator control and/or a second operator control and a mounting structure and a post configured to secure the operator control to the mounting structure; the configuration may comprise (a) the first operator control or (b) the second operator control or (c) the first operator control above the second operator control or (d) the first operator control under the second operator control. The first operator control may comprise the seatpost dropper control. The second operator control may comprise the suspension damping adjuster control. The first operator control may comprise an actuator assembly and the second operator control may comprise an actuator assembly. The first operator control may comprise a remote actuator assembly and the second operator control may comprise a remote actuator assembly. The assembly may comprise a spacer between the seatpost dropper control and the suspension damping adjuster control. The post may be configured to mount the operator control to the mounting structure. The post may comprise either a short post configured for mounting a single operator control or a long post configured for mounting of two operator controls; the post may comprise either a short post configured for mounting the configuration comprising a single operator control or a long post configured for mounting the configuration comprising two operator controls. A spacer may be secured between the seatpost dropper control and the suspension damping adjuster control. The assembly may comprise a stack comprising the seatpost dropper control above the suspension damping adjuster control; the stack may comprise the seatpost dropper control under the suspension damping adjuster control; the stack may comprise the spacer between the seatpost dropper control and the suspension damping adjuster control. The spacer may comprise a bushing. The spacer may comprise a tube.

TABLE A
REFERENCE SYMBOL LIST

| REFERENCE | ELEMENT, PART |
|---|---|
| SYMBOL | OR COMPONENT |
| B | BICYCLE |
| FR | FRAME |
| FW | FRONT WHEEL |
| RW | REAR WHEEL |
| SP | SEAT POST |
| S | SEAT |
| T | STEERING TUBE |
| ST | STEM |
| H | HANDLEBAR |
| G | GRIP (HANDLEBAR) |
| F | FRONT FORK ASSEMBLY |
| SH | REAR SHOCK ABSORBER |
| | FOR SUSPENSION SYSTEM |
| BR | BRAKE SYSTEM |
| D | DISC/ROTOR (BRAKE) |
| P | PEDAL |
| TL | TOOL |
| RH | REAR HUB |
| RL | REMOTE LEVER. |

TABLE B
REFERENCE SYMBOL LIST

| REFERENCE | |
|---|---|
| SYMBOL | ELEMENT, PART OR COMPONENT |
| 110 | REMOTE ASSEMBLY |
| | (DROPPER SEATPOST OVER SUSPENSION |
| | DAMPING ADJUSTER CONTROL) |
| 210 | REMOTE ASSEMBLY |
| | (DROPPER SEATPOST UNDER SUSPENSION |
| | DAMPING ADJUSTER CONTROL) |
| 310 | REMOTE ASSEMBLY (DROPPER SEATPOST) |
| 410 | REMOTE ASSEMBLY (SUSPENSION DAMPING |
| | ADJUSTER CONTROL) |
| 12/312 | PIVOT PIN |
| 12a/312a | SHAFT (PIVOT PIN) |
| 12b/312b | KEY (PIVOT PIN) |
| 14 | MOUNT PLATE (MULTIPLE MOUNTING |
| | POSITIONS) |
| 16 | SPACER |
| 18 | SCREW |
| 20 | CLAMP ASSEMBLY |
| 100 | ACTUATOR ASSEMBLY |
| 102 | BASE PLATE |
| 102a | HOLE (BASE PLATE) |
| 102b | KEY (BASE PLATE) |
| 102c | RECESS (BASE PLATE) |
| 104 | WASHER |
| 108 | LEVER ASSEMBLY (REMOTE LEVER) |
| 108x | LEVER PAD |
| 116 | ADJUSTER ASSEMBLY |
| 122 | HOUSING |
| 124 | CABLE/WIRE |
| 150 | ACTUATOR ASSEMBLY |
| 152 | BASE PLATE |
| 152a | HOLE (BASE PLATE) |
| 152b | KEY (BASE PLATE) |
| 152c | RECESS (BASE PLATE) |
| 154 | WASHER |
| 158 | LOCK LEVER ASSEMBLY (REMOTE LEVER) |
| 158x | LEVER PAD |
| 164 | TORSION SPRING |
| 166 | RELEASE LEVER ASSEMBLY (REMOTE LEVER) |
| 166x | LEVER PAD |
| 172 | SCREW |
| 182 | HOUSING |
| 184 | CABLE/WIRE |
| 192 | HOUSING |
| 194 | CABLE/WIRE. |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A reconfigurable operator control assembly configured to provide at least one configuration comprising:
a first operator control and/or a second operator control;
a mounting structure;
a post configured to secure the operator control to the mounting structure;
wherein the configuration comprises (a) the first operator control or (b) the second operator control or (c) the first operator control above the second operator control or (d) the first operator control below the second operator control.

2. The assembly of claim 1 wherein the first operator control comprises a remote actuator assembly and/or the second operator control comprises a remote actuator assembly.

3. The assembly of claim 1 wherein the post comprises (a) a short post configured for mounting a configuration comprising the first operator control or the second operator control or (b) a long post configured for mounting a configuration comprising the first operator control and the second operator control; wherein the long post is longer than the short post.

4. The assembly of claim 1 further comprising a stack comprising the first operator control and the second operator control; and a spacer between the first operator control and the second operator control; wherein the post is configured to fit within the spacer.

5. The assembly of claim 1 wherein the first operator control comprises a seatpost dropper control or a suspension damping adjuster control; wherein the second operator control comprises a seatpost dropper control or a suspension damping adjuster control.

6. The assembly of claim 5 further comprising a stack comprising (a) the seatpost dropper control above the suspension damping adjuster control or (b) the seatpost dropper control under below the suspension damping adjuster control.

7. The assembly of claim 5 wherein the at least one configuration comprises (a) the seatpost dropper control or (b) the suspension damping adjuster control or (c) the seatpost dropper control above the suspension damping adjuster control or (d) the seatpost dropper control below the suspension damping adjuster control.

8. The assembly of claim 5 wherein the at least one configuration comprises (a) the seatpost dropper control wherein the post comprises a short post or (b) the suspension damping adjuster control wherein the post comprises a short post or (c) the seatpost dropper control above the suspension damping adjuster control wherein the post comprises a long post secured through a spacer with a fastener and a fastener to secure to the mounting structure or (d) the seatpost dropper control below the suspension damping adjuster control wherein the post comprises a long post secured through a spacer with a fastener and a fastener to secure to the mounting structure.

9. The assembly of claim 1 further comprising a lever and connection of a cable.

10. The assembly of claim 1 wherein the post comprises a noncircular cross-section.

11. The assembly of claim 1 wherein the mounting structure comprises a clamp assembly.

12. The assembly of claim 1 further comprising a base plate configured to be secured to the mounting structure; wherein the base plate comprises a key.

13. A reconfigurable operator control assembly comprising:
(a) an operator control comprising at least one operator control;
(b) a mounting structure;
(c) a post configured to secure the operator control to the mounting structure;
wherein the operator control comprises a seatpost dropper control and/or a suspension damping adjuster control.

14. The assembly of claim 13 wherein the post comprises a body; wherein the body comprises a non-circular cross-section.

15. The assembly of claim 13 further comprising a stack comprising (a) the seatpost dropper control above the suspension damping adjuster control or (b) the seatpost dropper control under below the suspension damping adjuster control.

16. The assembly of claim 13 wherein the at least one operator control comprises (a) the seatpost dropper control above the suspension damping adjuster control or (b) the seatpost dropper control below the suspension damping adjuster control or (c) the seatpost dropper control or (d) the suspension damping adjuster control.

17. The assembly of claim 13 configured to provide multiple arrangements; wherein the post comprises a short post or a long post; wherein the long post is longer than the short post; wherein the short post is configured for mounting an arrangement comprising the seatpost dropper control or the suspension damping adjuster control; wherein the long post is configured for mounting an arrangement comprising the seatpost dropper control and the suspension damping adjuster control.

18. A reconfigurable operator control assembly comprising:
(a) a first operator control;
(b) a second operator control;
(c) a mounting structure;
(d) a post configured to secure the operator control to the mounting structure;
wherein the operator control assembly comprises (a) the first operator control above the second operator control or (b) the first operator control below the second operator control or (c) the first operator control or (d) the second operator control.

19. The assembly of claim 18 wherein the first operator control comprises a seatpost dropper control and the second operator control comprises a suspension damping adjuster control.

20. The assembly of claim 18 wherein the post comprises a short post configured for mounting the first operator control or a long post configured for mounting of the first operator control and the second operator control; wherein the long post is longer than the short post.
